(19) United States
(12) Patent Application Publication
(10) Pub. No.: US 2010/0189509 A1
(43) Pub. Date: Jul. 29, 2010

(54) GEOTECHNICAL APPLICATIONS OF IMPROVED NANOCOMPOSITES

(75) Inventors: Archibald S. Filshill, Hungtington Valley, PA (US); Jianbo Di, Palatine, IL (US); Jason M. Logsdon, Schaumburg, IL (US); Michael Donovan, Huntley, IL (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: AMCOL INTERNATIONAL CORPORATION, Hoffman Estates, IL (US)

(21) Appl. No.: 12/691,391

(22) Filed: Jan. 21, 2010

Related U.S. Application Data
(60) Provisional application No. 61/147,018, filed on Jan. 23, 2009.

(51) Int. Cl. B65G 5/00; B32B 3/10; C08K 3/34

(52) U.S. Cl. 405/55; 428/131; 524/445; 977/778

(57) ABSTRACT

The apparatuses, compositions and methods described herein generally relate to a new application for and formulation of composite-polymer composition. This composition is a nanocomposite, comprising a polymer and a clay, preferably a recycled polymer and a nanoclay. The nanocomposite composition has improved performance characteristics, such as lower creep values and lower coefficients of linear thermal expansion, and can reduce the dependency of plastic product manufacturing on virgin (unrecycled) polymers. Moreover, the nanocomposite is formed into geosynthetic materials, e.g., geomembranes, and storm water retention/detention systems.

### CROSS-REFERENCE TO RELATED APPLICATION

This application is a non-provisional patent application that claims the benefit of U.S. Provisional Patent Application No. 61/147,018 filed Jan. 23, 2009. The text of the priority application is incorporated herein by reference in its entirety.

### FIELD OF THE INVENTION

The current disclosure relates to the improvements in the strength and creep resistance of polymer materials for use in geotechnical and structural applications.

### BACKGROUND AND PRIOR ART

Geosynthetic materials include geotextiles, geomembranes, geogrids, geonets, geocomposites, geosynthetic clay liners, geopipe, geofoam structures, and the like. These products have a wide range of applications and are currently used in many civil and geotechnical engineering applications including roads, airfields, railroads, embankments, retaining structures, reservoirs, canals, dams, bank protection and coastal engineering.

Geomembranes are impermeable membranes widely used as cut-offs and liners in canals, ponds, and wastewater lagoons. One of the largest current applications is at landfill sites for the containment of hazardous or municipal wastes and their leachates to prevent wastes from reaching grounds water supplies. In many of these applications, geomembranes are employed with geotextile or mesh underliners which reinforce or protect the more flexible geomembrane whilst also acting as an escape route for gases and leachates generated in certain wastes. Commercial geomembranes are made of Low-Density Polyethylene (LDPE), High-Density Polyethylene (HDPE), Polyvinyl Chloride (PVC), Polyurea and Polypropylene (PP). Another type of geomembrane is bituminous geomembrane, which is actually a layered product of glass and bitumem-impregnated non-woven geotextile.

There are design issues and needs for improvement known in the art associated with geomembranes made of LDPE, HDPE and other virgin plastics. First, geomembranes made of virgin plastics sometimes develop wrinkles after installation once they are heated by the sunshine, which increase the potential leakage through the geomembrane. Second, for applications like linings for waste disposal facilities and methane barriers, the impermeability for gases is important in selecting geomembranes. Lower gas transmission is desired for methane, radon, water vapor, and the like. Third, there is a need to improve the chemical resistance of existing geomembranes so that the performance is not adversely affected by most common chemicals encountered in a waste containment environment.

Underground storm water storage systems store and release water at a controlled rate per the increasingly stringent environmental requirements. Various shaped or molded water containment structures made of concrete, steel or plastic have been employed underground to capture storm water. Plastic storage systems offer unique advantages including lower weight, ease of installation and more freedom in design. The drawbacks of existing plastic storage systems lie in several aspects. First, the relatively low modules and creep strength of plastics compared with concrete increases the potential for failure in the field. In practice there have been reported collapses of HDPE storm water storage structures a few months after installation, due to the creep of HDPE under the pressure coming from backfill as well as structures and/or automobiles above the ground. Therefore, improving the modulus and creep performance of plastic storage system is desired to ensure its use life. Second, in case of storage systems installed below a parking lot, the run-off from the parking lot quite often contains oil, gasoline, anti-freeze and other types of chemicals. Therefore, it is desired to improve the chemical resistance of the storage system.

In accordance with the present invention, improved geosynthetic materials including geotextiles, geomembranes, geogrids, geonets, geocomposites, geosynthetic clay liners, geopipe and geofoam made of polymer silicate nanocomposites are provided. Compared with systems made of virgin plastics, these new systems provide a unique combination of higher chemical resistance, lower methane and radon transmission, improved creep strength, lower coefficient of thermal expansion, higher puncture strength and elastic modulus. In addition to the improved properties, this approach allows for greater use of recycled virgin plastics or nanocomposites from both post consumer and post industrial sources in the feed stream without compromising the final properties.

### SUMMARY

In brief, the present invention is directed to a method of making and using a nanocomposite. In accordance with the compositions and methods described herein, the nanocomposite is made with a polymer or plastic admixed with a clay, wherein the clay has been intercalated with an onium ion to expand the d-spacing sufficiently for at least partial exfoliation of the clay in the nanocomposite composition. The, as made, nanocomposite is a geosynthetic material applied in geotechnical applications, for example controlling water flow, water storage, permeation of water into the ground, gas (especially methane and radon) emission and noxious chemical release.

Preferred nanocomposite compositions and articles of manufacture are made with a recycled polymer or recycled plastic (herein, used interchangeably) admixed with a clay thereby reducing, in part, the environmental impact from the disposal of polymer materials. Additionally, the mixing of the clay with the recycled polymer increases the strength and utility of the recycled polymer and improves the recyclability of the polymer.

An important aspect compositions, articles and methods described herein is the admixing of a clay with a recycled polymer. In accordance with one embodiment of the compositions and methods described herein, the clay is mechanically processed with the recycled polymer and the resulting nanocomposite is formed into a consumer product.

Another important aspect of the compositions, articles and methods described herein is delaminating (exfoliating) the clay. The clays used in the present invention are mechanically and chemically delaminated. The clays can also be intercalated and at least partially exfoliated prior to admixing with the recycled polymer. To achieve the full advantage of the compositions and methods described herein, the clays are finely divided and are in effect, nanoclays.

Accordingly, an object of the compositions, articles and methods described herein is to provide a new and improved method for physically and chemically processing post-consumer and/or post-industrial recycled plastic.

Yet another important aspect of the compositions, articles and methods described herein is the use of the geosynthetic materials made from nanocomposites in geotechnical applications. These applications include in part underlayment for landfills, overlayment for landfills, storm water pipes, and storm water storage systems. To achieve the full advantage of geosynthetic materials in these applications the nanocomposites have improved coefficients of linear expansion, improved puncture strength, lower gas permeability, lower creep, and/or higher chemical resistance.

The above and other objects and advantages of the invention will become apparent from the following detailed description of the preferred embodiments described with reference to the drawings.

### BRIEF DESCRIPTION OF THE DRAWINGS

FIG. 1 is a plot of experimental and extrapolated data from a time-dependent loading strain measurement (ASTM D 6992) better known as a measurement of Creep at 500 psi for low density polyethylene.

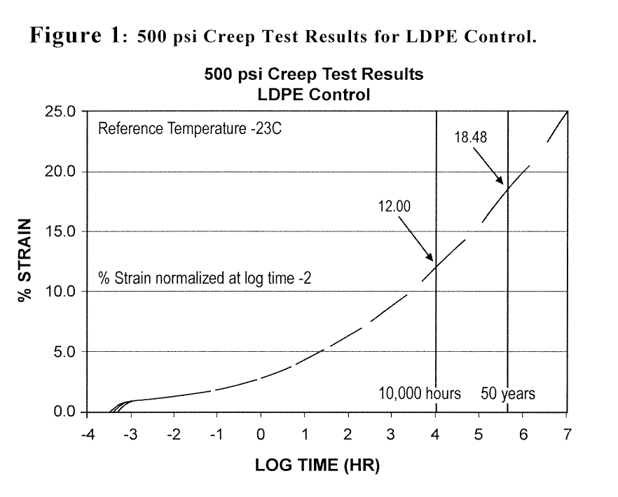

FIG. 2 is a plot of experimental and extrapolated data from a time-dependent loading strain measurement (ASTM D 6992) better known as a measurement of Creep at 500 psi for a nanocomposite having low density polyethylene, 3 wt. % nanoclay, and 3 wt. % compatibilizer.

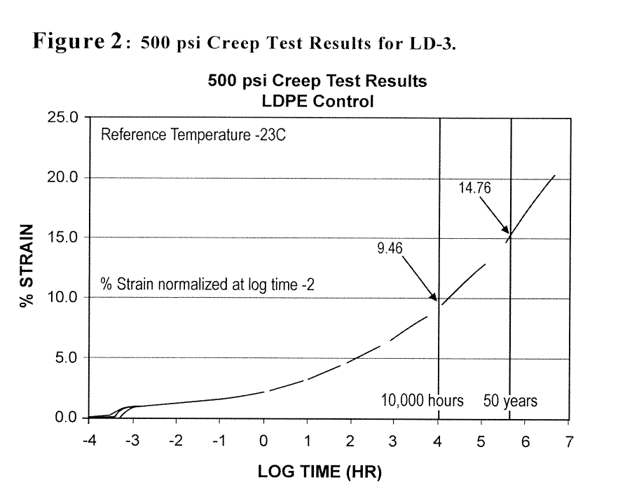

FIG. 3 is a plot of experimental and extrapolated data from a time-dependent loading strain measurement (ASTM D 6992) better known as a measurement of Creep at 500 psi for a nanocomposite having low density polyethylene, 6 wt. % nanoclay, and 6 wt. % compatibilizer.

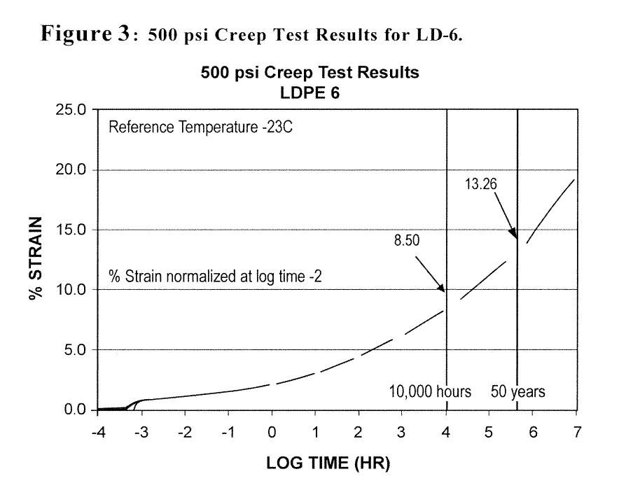

FIG. 4 is a plot of experimental and extrapolated data from a time-dependent loading strain measurement (ASTM D 6992) better known as a measurement of Creep at 500 psi for a nanocomposite having low density polyethylene, 9 wt. % nanoclay, and 9 wt. % compatibilizer.

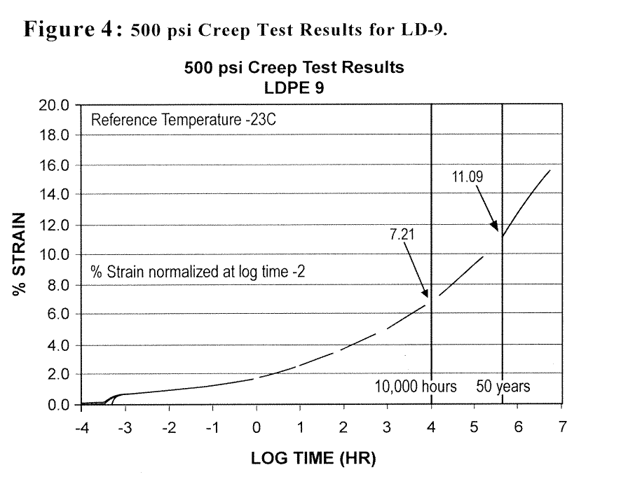

FIG. 5 is a plot of experimental and extrapolated data from a time-dependent loading strain measurement (ASTM D 6992) better known as a measurement of Creep at 500 psi for high density polyethylene.

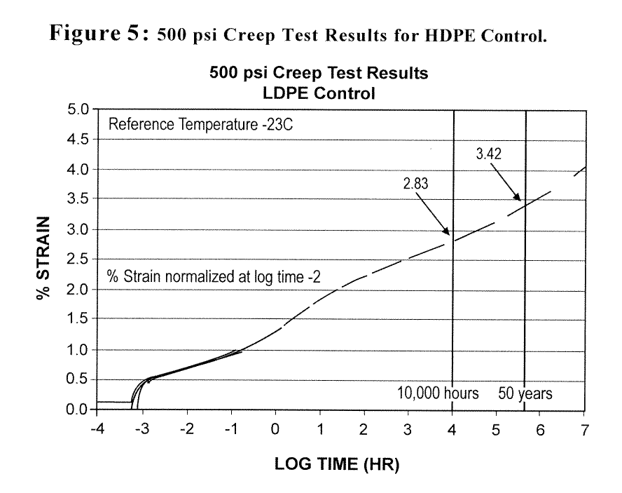

FIG. 6 is a plot of experimental and extrapolated data from a time-dependent loading strain measurement (ASTM D 6992) better known as a measurement of Creep at 500 psi for a nanocomposite having high density polyethylene, 3 wt. % nanoclay, and 3 wt. % compatibilizer.

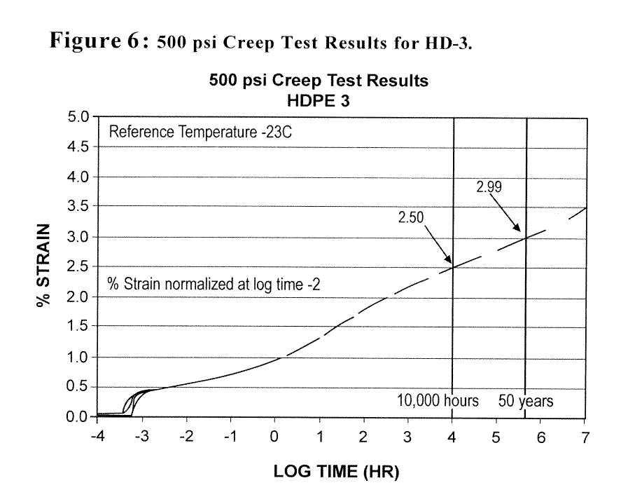

FIG. 7 is a plot of experimental and extrapolated data from a time-dependent loading strain measurement (ASTM D 6992) better known as a measurement of Creep at 500 psi for a nanocomposite having high density polyethylene, 6 wt. % nanoclay, and 6 wt. % compatibilizer.

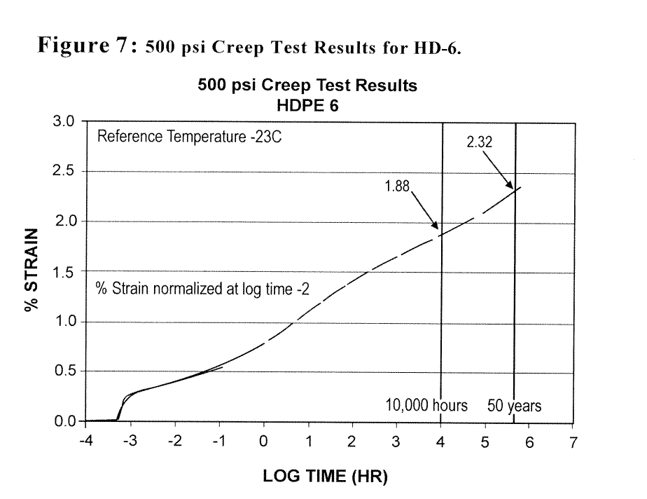

FIG. 8 is a plot of experimental and extrapolated data from a time-dependent loading strain measurement (ASTM D 6992) better known as a measurement of Creep at 500 psi for a nanocomposite having high density polyethylene, 9 wt. % nanoclay, and 9 wt. % compatibilizer.

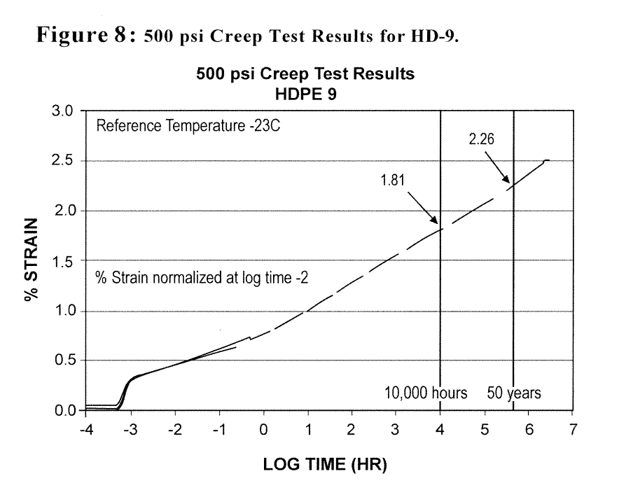

FIG. 9 is a comparison of the relative changes to the young's modulus of low density polyethylene and high density polyethylene with 0 wt. %, 3 wt. %, 6 wt. %, and 9 wt. % nanoclay loadings.

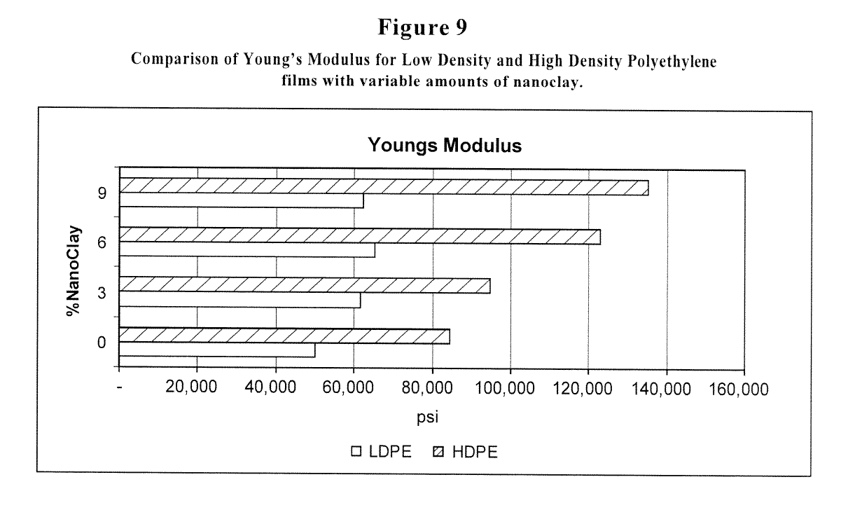

FIG. 10 is a comparison of the relative changes to the yield strength of low density polyethylene and high density polyethylene with 0 wt. %, 3 wt. %, 6 wt. %, and 9 wt. % nanoclay loadings.

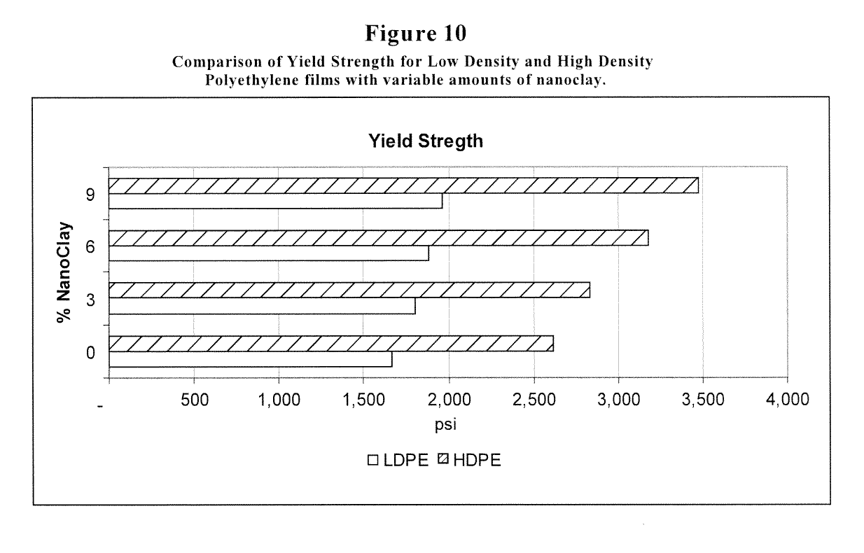

FIG. 11 is one example of a void creating unit for the construction of a water retention/detention system. The entire void creating unit can be constructed from the herein defined nanocomposites and/or recycled nanocomposites. The void creating unit has a porous top member 111, a porous bottom member 112, and porous side members 113 (only one of which is shown), and support units 114 between the top member and the bottom member. The top, bottom, and side members are porous, having flow pathways 115 that allow water to enter and exit the void 116. In operation in a water retention/detention system, a plurality of the void creating units can be combined to create a larger total volume for retaining/detaining water.

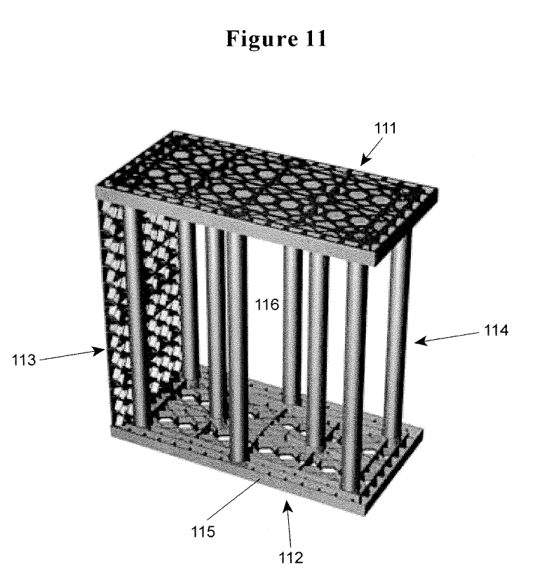

FIG. 12 is one example of a void creating units in a water retention/detention system, wherein the convex corrugated units create a void space under the apex of the curve. The entire void creating unit can be constructed from the herein defined nanocomposites and/or recycled nanocomposites. The void creating unit has a concave structure 121 that creates a void 112 under the apex of the structure. Generally, water enters the system via one or a series of pipes 124. Often to permit the retained/detained water to soak into the soil the end of the concave structure 121 is capped with an end member 123.

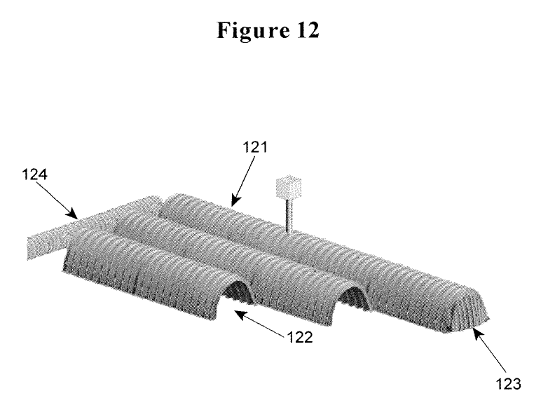

FIG. 13 is one example of a stackable void creating unit for the construction of a water retention/detention system. The entire void creating unit can be constructed from the herein defined nanocomposites and/or recycled nanocomposites. The void creating unit has a stackable structure where cylinders 131 can preferentially stack upon one another (not shown). The cylinders 131 are interconnected by rods 132 that provide tangential support to the unit. The space between the cylinders, as maintained by the rods, defines the water fillable void 133.

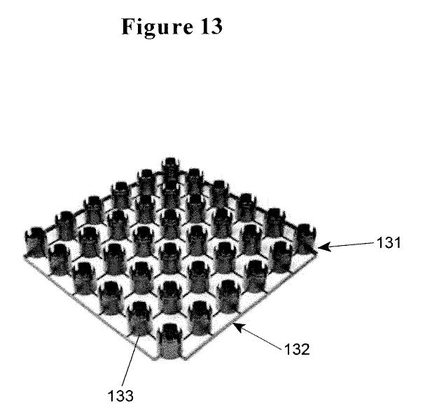

FIG. 14 is one example of a stackable, cubic void creating unit for the construction of a water retention/detention system. The entire void creating unit can be constructed from the herein defined nanocomposites and/or recycled nanocomposites. The void creating unit has side members 141 on all six sides defining a water fillable, cubic void 142. The side members 141 have flow paths 143 that allow water to enter and exit the unit. Often (not shown) the unit has internal support that strengthens and maintains the cubic shape of the unit.

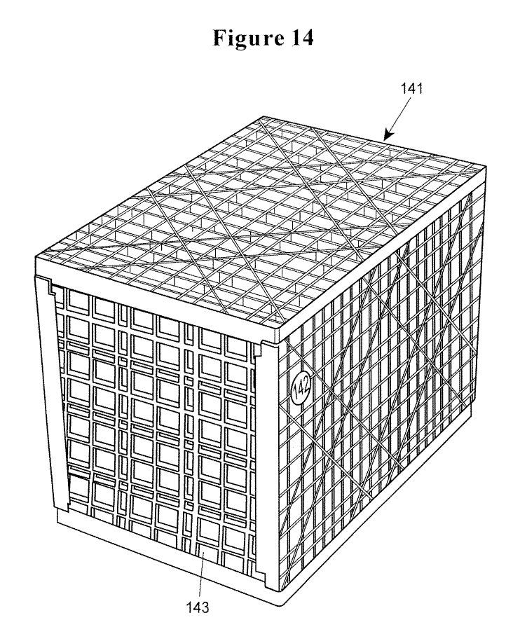

FIG. 15 is one example of a water retention/detention system employing void creating units 5. Surface or storm or waste water enters the water retention/detention system through any one of a possible plurality of water entry points 2, 4. Water can either directly enter the water retention/detention system or can enter a water reservoir 3 and then flow into the water retention/detention system through a sediment screen or filter 10. When the water retention/detention system is designed for permeation of the water into the water table, the water retention/detention system may include a geomembrane 6 that covers the water retention/detention system while leaving the bottom of the system open to gravel, sand, soil, or the like 9. The geomembrane prevents soil, sand, or other solid matter from entering the water retention/detention system from the sides or above and thereby decreasing the void space within the system. Often water retention/detention systems include a overfill run off 8 wherein extraordinary amounts of water can be diverted from the system thereby preventing the physical lifting or other detrimental harm to the system.

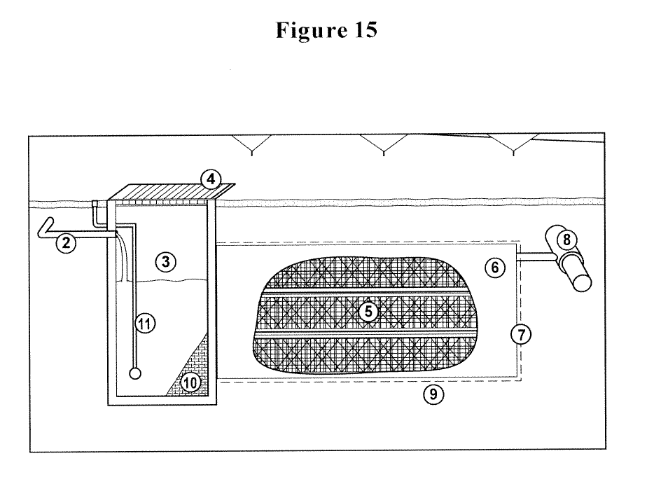

FIG. 16 is one example of a paving grid. The grid 161 has a series of open cells 162 that permit liquids to flow through the grid 161 while holding a porous material within the grid. Often the paving grid consists of a plurality of interconnected cells.

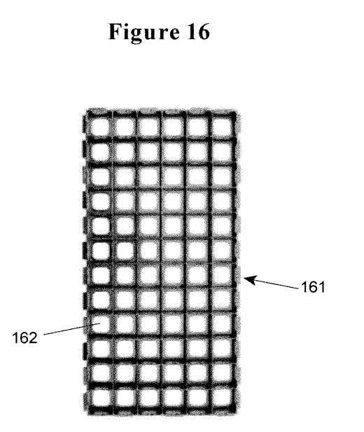

FIG. 17 is one example of an erosion protection system in place on a slope. The erosion protection has a series open voids 171 defined by the geosynthetic material 172. In place, the erosion protection system can hold soil 173 and prevent the soil 173 from flowing down the slope upon application of water. Additionally, the soil 173 permits the growth of vegetation 174 that further restricts the erosion of soil from the slope.

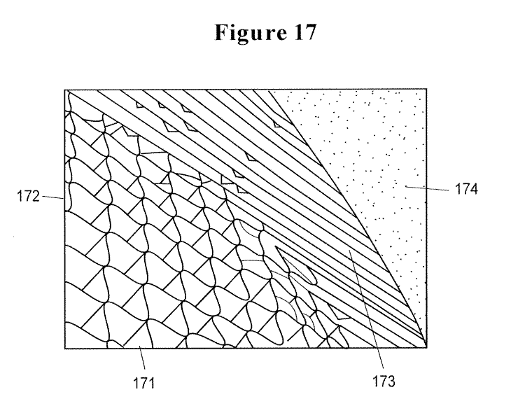

### DETAILED DESCRIPTION OF THE INVENTION

Herein, ranges may be expressed as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The apparatuses, compositions, articles of manufacture and methods described herein generally relate to a new applications for and formulations of composite-polymer compositions. These compositions are nanocomposites comprising a polymer and a clay, preferably a recycled polymer and a nanoclay. The nanocomposite compositions have improved performance characteristics, such as lower creep values and lower coefficients of linear thermal expansion, and can reduce the dependency of plastic product manufacturing on virgin (unrecycled) polymers. Moreover, these nanocomposites may be formed into geosynthetic materials, e.g., geomembranes, and storm water retention/detention systems.

### Nanocomposite Compositions

As used herein a nanocomposite refers to a mixture of a recycled polymer and a clay that has been at least partially exfoliated. The nanocomposite may also contain virgin polymer. The method of mixing the recycled polymer and the clay can include compounding, extruding, blending, and/or any other method know in the art to mix polymers with clays and at least partially exfoliate the clay into individual clay platelets and tactoids of 2-15, preferably 2-10 stacked platelets.

A recycled polymer is a polymer material recovered after some use. The use can include the casting and forming of polymers into products and/or the application of the formed polymers for a specified purpose. Two types of recycled polymers exist: post-industrial and post-consumer. Generally, post-industrial recycled polymers are those polymer materials that are scrap materials from an industrial manufacturing process. Commonly, post-industrial recycled polymers are not contaminated with other materials or other polymers and can be readily blended with the corresponding virgin polymers. Often design and performance specifications limit the amount of post-industrial recycled polymer a company or individual can blend with a virgin polymer. Post-consumer recycled polymers are those polymer materials that were formed into consumer materials and used by a consumer. Commonly, the post-consumer recycled polymers are available through a municipalities recycling program. Additionally, post-consumer recycled polymers are generally recycled only one time because of a degradation in the polymers physical properties due to the recycling process.

Post-industrial and/or post-consumer recycled polymers are classified into one of the seven plastic code numbers. These recycled polymers are generally polyethylene terephthalate (code no. 1), polyethylene (high density polyethylene, code no. 2; low density polyethylene, code no. 4), polyvinyl chloride (code no. 3), polypropylene (code no. 5), polystyrene (code no. 6), polycarbonate, and other plastics (code no. 7) (e.g., nylon). Usually, municipal recycling programs focus solely on plastic containers made from polyethylene terephthalate and high density polyethylene because these polymers, post-consumer, have the largest use and resale market.

In the preferred embodiment of the nanocomposites disclosed herein, the polymer comprises 0% to 99% by weight of a virgin polymer and 1% to 100% by weight of a recycled polymer that consists of 0% to 100% by weight post consumer polymer and 0% to 100% by weight of a post industrial polymer. Preferably, the polymer comprises 0% to 75%, more preferably 0% to 50%, and still more preferably 0% to 25% by weight of the virgin polymer. In many preferred embodiments the nanocomposite includes no virgin polymer.

Preferably, the recycled polymer, prior to the formation of the herein disclosed nanocomposite, includes less than about 10% by weight of a nanoclay. More preferably, the recycled polymer, prior to the formation of the herein disclosed nanocomposite, is essentially free of nanoclay, this means the recycled polymer preferably includes less than 2%, more preferably less than 1%, still more preferably less than 0.5%, even still more preferably less than 0.1%, and yet more preferably less than 0.01% by weight of a nanoclay.

The clays applicable herein are those phyllosilicates, such as smectite clays, e.g., sodium montmorillonite and calcium montmorillonite, that can be treated with organic molecules, such as organic ammonium ions, to intercalate the organic molecules between adjacent, planar silicate layers, for intercalation of the polymer between the layers, thereby substantially increasing the interlayer (interlaminar) spacing between the adjacent silicate layers. The thus-treated, intercalated phyllosilicates, having interlayer spacings increased by at least 3 Å, preferably at least 5 Å, e.g., to an interlayer (interlaminar) spacing of at least about 10-25 Å and up to about 100 Å, then can be exfoliated by, for example, by high shear mixing, as well known in the art. The clays useful herein are nanoclays (exfoliated, onium ion intercalated, smectite clays with one dimension in the nanometer range).

The amount of clay mixed with the recycled polymer may vary widely. Clay loadings are within the range of about 0.01% to about 40% by weight, preferably about 0.05% to about 20%, more preferably about 0.5% to about 15%, still more preferably about 1% to about 10% of the total weight of the composition. It is preferred that the clay loading be less than about 15% by weight of the nanocomposite.

The utility of polymers and/or polymer composites is wholly dependant on the properties of the polymers and/or polymer composites. The properties of recycled polymers or recycled polymer composites are often inferior to the properties of corresponding virgin polymers or virgin polymer composites, due to degradations caused by aging, weathering, additional heat processing, and then like. Post-industrial recycled polymers also possess inferior properties due to reprocessing of the materials during the formation of polymer products. In many cases a single recycling process harms the physical properties of polymers by 40%, for example strength, creep resistance, impact resistance, stiffness, tear resistance, and Young's modulus.

In accordance with the methods and compositions described herein, the dispersion of clay into a recycled polymer remarkably and unexpectedly improves the polymer's physical properties, compensating for the harm known to occur with recycling. Because of the improvement in the polymer's physical properties, these recycled polymer nanocomposites can be used in place of virgin polymers, especially in applications where conditions demand superior physical property. In addition, the herein described recycled polymer nanocomposites have improved property retention, that is the physical properties persist without significant detrimental affect through additional recycling steps, in comparison with polymers without nanoclay.

Additionally, the nanocomposites described herein can be admixed with polymer modifiers to improve the thermal stability, flexibility, surface energy, coefficient of friction, oleo or hydrophobicity, and the like. These polymer modifiers may be tougheners, plasticizers, polymer compatiblizers, impact modifiers, UV protecting agents, and/or stabilizers. Conventional ingredients include antiblocking agent, antistatic agents, antioxidants, blowing agents, polymer compatiblizers, crystallization aides, dyes, extenders, flame retardants, fillers, impact modifiers, mold release agents, oils, pigments, performance additives, plasticizers, processing agents, reinforcing agents, polymer stabilizers, UV light absorbers, photostabilizers for UV light absorbers, and the like. Performances additives can improve polymer performances like: Young's modulus, stiffness, elongation at break, impact resistance, creep, fatigue, elasticity, flexibility, strength, temperature resistance, electrical insulation, transparency, haze, HDT, Vicat, weatherability, tear resistance, gloss, matt, opacity, flame retardancy, fire resistance, and glass transition; the performance additives are often extenders, flame retardants, fillers, impact modifiers, UV stabilizers, and/or plasticizers.

Additionally useful polymer modifiers are UV light absorbers. Herein, UV light absorbers are those chemicals added to polymers to prevent photochemical degradation of the polymer. Preferably, UV light absorbers are a naphthalate polyester, a cinnamic acid derivative, carbon, and/or a dibenzoylmethane derivative. Particularly preferable UV light absorbers include 2-ethylhexyl methoxycinnamate, 4-tert-butyl-4-methoxy dibenzoylmethane, and/or carbon.

Applicable UV light absorbers include p-aminobenzoic acid and salts and derivatives thereof; anthranilate and derivatives thereof; dibenzoylmethane and derivatives thereof; salicylate and derivatives thereof; cinnamic acid and derivatives thereof (e.g., 2-ethylhexyl methoxycinnamate); dihydroxycinnamic acid and derivatives thereof; camphor and salts and derivatives thereof; trihydroxycinnamic acid and derivatives thereof; dibenzalacetone naphtholsulfonate and salts and derivatives thereof; benzalacetophenone naphtholsulfonate and salts and derivatives thereof; dihydroxy-naphthoic acid and salts thereof; o-hydroxydiphenyldisulfonate and salts and derivatives thereof; p-hydroxydiphenyldisulfonate and salts and derivatives thereof; coumarin and derivatives thereof; diazole derivatives; quinine derivatives and salts thereof; quinoline derivatives; hydroxy-substituted benzophenone derivatives; methoxy-substituted benzophenone derivatives; uric acid derivatives; vilouric acid derivatives; tannic acid and derivatives thereof; hydroquinone; benzophenone derivatives; 1,3,5-triazine derivatives, phenyldibenzimidazole tetrasulfonate and salts and derivatives thereof; terephthalylidene dicamphor sulfonic acid and salts and derivatives thereof; methylene bis-benzotriazolyl tetramethylbutylphenol and salts and derivatives thereof; bis-ethylhexyloxyphenol methoxyphenyl triazine and salts and derivatives thereof; diethylamino hydroxybenzoyl hexyl benzoate and salts and derivatives thereof.

Additional, applicable UV light absorbers include 2-methyldibenzoylmethane, 2 4-dimethyl-4′-methoxydibenzoylmethane, 2 4-dimethyldibenzoylmethane, 2 5-dimethyldibenzoylmethane, 2 6-dimethyl-4-tert-butyl-4′-methoxydibenzoylmethane, 2-methyl-5-isopropyl-4′-methoxydibenzoylmethane, 2-methyl-5-tert-butyl-4′-methoxydibenzoylmethane, 3-benzylidene-camphor, 4 4′-diisopropyldibenzoylmethane, 4 4′-dimethoxydibenzoylmethane, 4-isopropyldibenzoylmethane, 4-methylbenzylidene camphor, 4-methyldibenzoylmethane, 4-tert-butyl-4′-methoxydibenzoylmethane, 4-tert-butyldibenzoylmethane, aminobenzoic acid (also called para-aminobenzoic acid and PABA), Avobenzone (also called butyl-methoxy-dibenzoylmethane), benzylidene-camphor sulfonic acid, bisethylhexyloxyphenol methoxyphenyl triazine (also called TINOSORB S or Bemotrizinol), camphor benzalkonium methosulfate, cinoxate (also called 2-ethoxyethyl-p-methoxycinnamate), diethanolamine-methoxycinnamate, diethylhexyl-butamido-triazone, dioxybenzone (also called benzophenone 8), disodium phenyl-dibenzimidazole tetrasulfonate, drometrizole-trisiloxane, ethyl-[bis(hydroxypropyl)]-aminobenzoate, ethylhexyl-dimethyl PABA, ethylhexyl-methoxycinnamate, ethylhexyl-salicylate, ethylhexyl-triazone, glyceryl-aminobenzoate, homosalate (also called 3 3 5-trimethylcyclohexyl salicylate), isoamyl-p-methoxycinnamate, menthyl-anthranilate (also called menthyl-2-aminobenzoate), methylene-bisbenzotriazolyl tetramethylbutylphenol (also called TINOSORB M or Bisoctrizole), octocrylene (also called 2-ethylhexyl-2-cyano-3 3-diphenylacrylate), octyl salicylate (also called 2-ethylhexyl-salicylate), octyl-methoxycinnamate, oxybenzone (also called benzophenone-3), padimate O (also called octyl-dimethyl PABA), PEG 25 PABA, phenylbenzimidazole sulfonic acid, polyacrylamidomethyl-benzylidene camphor, sulisobenzone (also called benzophenone-4), terephthalidene-dicamphor sulfonic acid, titanium dioxide, trolamine salicylate (also called triethanolamine salicylate), zinc oxide, derivatives, and mixtures thereof. A particularly preferred UV light absorbers is carbon black.

Preferred dibenzoylmethane derivatives include, 2-methyldibenzoylmethane; 4-methyldibenzoylmethane; 4-isopropyldibenzoylmethane; 4-tert-butyldibenzoylmethane; 2,4-dimethyldibenzoylmethane; 2,5-dimethyldibenzoylmethane; 4,4′-diisopropyldibenzoylmethane; 4,4′-dimethoxydibenzoylmethane; 4-tert-butyl-4′-methoxydibenzoylmethane; 2-methyl-5-isopropyl-4′-methoxydibenzoylmethane; 2-methyl-5-tert-butyl-4′-methoxydibenzoylmethane; 2,4-dimethyl-4′-methoxydibenzoylmethane; 2,6-dimethyl-4-tert-butyl-4′-methoxydibenzoylmethane; and combinations thereof.

The amount of UV light absorbers included may vary widely. UV light absorbers loadings within the range of about 0.01% to about 20% by weight, preferably about 0.05% to about 10%, more preferably about 1% to about 10% of the total weight of the composition. It is preferred that the UV light absorbers loading be less than about 5% by weight of the nanocomposite.

Additional polymer modifiers are stabilizers. Stabilizers are those chemicals added to a polymer to prevent, for example, yellowing, discoloration, chalking, hazing, whitening, crazing, cracking, oxidation, hydrolysis, heat degradation, degradation by oxidation, degradation by UV light, degradation by E-beam, degradation by X ray, and/or degradation by sterilization. Some applicable stabilizers are UV-stabilizers, of which UV light absorbers are a subset. Additional stabilizers are antioxidants.

Antioxidants include, for example, penterythritol tetrakis (3-(3,5-di-t-butyl-4-hydroxyphenyl)propionate), 1,3,5-tris(3,5-di-tert-butyl-4-hydroxybenzyl)-1,3,5-triazine-2,4,6(1 h,3 h,5 h)-trione, nonylphenol disulfide oligomer, 1,3,5-trimethyl-2,4,6-tris (3,5-di-tert-butyl-4-hydroxybenzyl) benzene, octadecyl-3-(3,5-di-t-butyl-4-hydroxyphenyl)-propionate, tris-(2,4-di-t-butylphenyl) phosphate, bis (2,4-di-t-butylphenyl)pentaerythritol diphosphite, carbon nanotubes, tris(2-chloroethyl)phosphite, triisopropylphosphite, trimethylphosphite, bis(2-ehylhexl)phosphate, and antioxidants of the types disclosed in U.S. Pat. Nos. 7,053,139; 6,759,461; 5,030,679; 4,822,839; and 4,107,144, incorporated herein by reference.

The amount of antioxidant included may vary widely. Antioxidant loadings within the range of about 0.01% to about 20% by weight, preferably about 0.05% to about 10%, more preferably about 0.5% to about 10% of the total weight of the composition. It is preferred that the antioxidant loading be less than about 10% by weight of the nanocomposite.

The amount of polymer modifier included may vary widely. Polymer modifier loadings are within the range of about 0.001% to about 40% by weight, preferably about 0.01% to about 20%, more preferably about 0.05% to about 10% of the total weight of the composition. It is preferred that the polymer modifier loading be less than about 15% by weight of the nanocomposite.

Polymer compatibilizers are those chemicals added to polymers to facilitate the blending of immiscible materials. Often polymer compatibilizers are added to polymers to facilitate the blending of two immiscible polymers, herein polymer compatibilizers are added to support the blending of the nanoclay into the polymer and/or to facilitate the blending of immiscible polymers.

Applicable polymer compatibilizers include copolyester elastomers; ethylene-unsaturated ester copolymers, such as ethylene-maleic anhydride copolymers; copolymers of ethylene and a carboxylic acid or acid derivative, such as ethylene-methyl acrylate copolymers; polyolefins or ethylene-unsaturated ester copolymers grafted with functional monomers, such as ethylene-methyl acrylate copolymers; copolymers of ethylene and a carboxylic acid or acid derivative, such as ethylene-methyl acrylate-maleic anhydride terpolymers; terpolymers of ethylene, unsaturated ester and a carboxylic acid or acid derivative, such as ethylene-methyl-methacrylic acid terpolymers; acrylic elastomers, such as acrylic rubbers; ethylene-octene copolymers (e.g., Engage 8150); and styrene-butadiene-styrene copolymers. A preferred copolyester elastomer is HYTREL™ HTR-6108; ethylene-maleic anhydride copolymer is Polybond™3009; ethylene-methyl acrylate copolymer is SP 2205™; ethylene-methyl acrylate copolymer grafted with maleic anhydride is DS1328/60™; ethylene-methyl acrylate-maleic anhydride terpolymer is Lotader™ 2400; ethylene-methyl-methacrylic acid terpolymer is Escor™ ATX-320, Escot™ ATX-325 or Escor™ XV-11.04; and acrylic rubber is Vamac™ G1.

Particularly preferred polymer compatibilizers include maleic anhydride grafted polypropylene, maleic-anhydride modified ethylene-propylene copolymer, maleic-anhydride modified ethylenepropylene diene terpolymer, and maleic-anhydride modified polystrene-block-poly(ethylene-butylene)-block-polystyrene.

The amount of polymer compatibilizer included may vary widely. Polymer compatibilizer loadings are within the range of about 0.01% to about 20% by weight, preferably about 0.05% to about 10%, more preferably about 2% to about 10% of the total weight of the composition. It is preferred that the polymer compatibilizer loading be about 5% by weight of the nanocomposite.

As described above, the clays applicable herein are those intercalated phyllosilicates. Intercalated phyllosilicates are described in this assignee's U.S. Patents, for example U.S. Pat. Nos. 6,632,868; 6,462,122; 6,391,449; 6,387,996; and 5,578,627, all hereby incorporated by reference. Intercalated phyllosilicates are produced through the addition of one or more intercalating agents to the phyllosilicates. The preferred intercalating agent is an onium ion spacing agent that intercalates via ion-exchange or ion-dipole attraction into the interlayer spaces between adjacent platelets, also called spacing agents as they increase the inter-platelet spacing.

Preferred onium ion spacing agents are primary, secondary, tertiary or quaternary onium ions having linear or branched alkyl, aryl groups with 1 to about 24 carbon atoms. The preferred onium ions are quaternary ammonium ions having one long chain alkyl group, ranging from C₆ to C₂₄, straight or branched chain, including mixtures of long chain groups, i.e., C₆, C₈, C₁₀, C₁₂, C₁₄, C₁₆, C₁₈, C₂₀, C₂₂ and C₂₄, alone or in any combination; and other groups selected from the group consisting of H, alkyl, benzyl, substituted benzyl, branched alkyl, and substituted aryl.

Additional useful multi-charged spacing/coupling agents include for example, tetra-, tri-, and di-onium species such as tetra-ammonium, tri-ammonium, and di-ammonium (primary, secondary, tertiary, and quaternary), -phosphonium, -oxonium, or -sulfonium derivatives of aliphatic, aromatic or arylaliphatic amines, phosphines, esters, alcohols and sulfides. Illustrative of such materials are di-onium compounds of the formula: R₁—X⁺R—Y⁺ where X⁺ and Y⁺, same or different, are ammonium, sulfonium, phosphonium, or oxonium radicals. Wherein, X⁺ is —NH(CH₃)⁺—, —NH₂⁺—, —N(CH₃)₂⁺—, —N(CH₃)(CH₂CH₃)⁺—, —N(CH₂CH₃)₂⁺—, —S(CH₃)⁺—, —P(CH₃)₂⁺—, and the like; Y⁺ is —NH(CH₃)₂⁺, —NH₂(CH₃)⁺, —N(CH₃)₃⁺, —N(CH₃)₂(CH₂CH₃)⁺, —N(CH₃)(CH₂CH₃)₂⁺, —S(CH₃)₂⁺, —S(CH₃)₂⁺, —P(CH₃)₃⁺, —NH₃⁺, and the like; R is an organic spacing, backbone radical, straight or branched, preferably having from 2 to 24, more preferably 3 to 10 carbon atoms, in a backbone organic spacing molecule covalently bonded at its ends to charged N, P, S and/or O cations and R₁ can be hydrogen, or an alkyl radical of 1 to 22 carbon atoms, linear or branched, preferably having at least 6 carbon atoms. Examples of R include substituted or unsubstituted alkylene, cycloalkenylene, cycloalkylene, arylene, alkylarylene, either unsubstituted or substituted with amino, alkylamino, dialkylamino, nitro, azido, alkenyl, alkoxy, cycloalkyl, cycloalkenyl, alkanoyl, alkylthio, alkyl, aryloxy, arylalkylamino, alkylamino, arylamino, dialkylamino, diarylamino, aryl, alkylsufinyl, aryloxy, alkylsulfinyl, alkylsulfonyl, arylthio, arylsulfinyl, alkoxycarbonyl, arylsulfonyl, or alkylsilane. Examples of R₁ include non-existent; H; alkyl having 1 to 22 carbon atoms, straight chain or branched; cycloalkenyl; cycloalkyl; aryl; alkylaryl, either unsubstituted or substituted or substituted with amino, alkylamino, dialkylamino, nitro, azido, alkenyl, alkoxy, cycloatkyl, cycloalkenyl, alkanoyl, alkylthio, alkyl, aryloxy, arylalkylamino, alkylamino, arylamino, dialkylamino, diarylamino, aryl, alkylsufinyl, aryloxy, alkylsulfinyl, alkylsulfonyl, arylthio, arylsulfinyl, alkoxycarbonyl, arylsulfonyl, or alkylsilane. Illustrative of useful R groups are alkylenes, such as methylene, ethylene, octylene, nonylene, tert-butylene, neopentylene, isopropylene, sec-butylene, dodecylene and the like; alkenylenes such as 1-propenylene, 1-butenylene, 1-pentenylene, 1-hexenylene, 1-heptenylene, 1-octenylene and the like; cycloalkenylenes such as cyclohexenylene, cyclopentenylene and the like; alkanoylalkylenes such as butanoyl octadecylene, pentanoyl nonadecylene, octanoyl pentadecylene, ethanoyl undecylene, propanoyl hexadecylene and the like; alkylaminoalkylenes, such as methylamino octadecylene, ethylamino pentadecylene, butylamino nonadecylene and the like; dialkylaminoalkylene, such as dimethylamino octadecylene, methylethylamino nonadecylene and the like; arylaminoalkylenes such as phenylamino octadecylene, p-methylphenylamino nonadecylene and the like; diarylaminoalkylenes, such as diphenylamino pentadecylene, p-nitrophenyl-p′-methylphenylamino octadecylene and the like; alkylarylaminoalkylenes, such as 2-phenyl-4-methylamino pentadecylene and the like; alkylsulfinylenes, alkylsulfonylenes, alkylthio, arylthio, arylsulfinylenes, and arylsulfonylenes such as butylthio octadecylene, neopentylthio pentadecylene, methylsulfinyl nonadecylene, benzylsulfinyl pentadecylene, phenylsulfinyl octadecylene, propylthiooctadecylene, octylthio pentadecylene, nonylsulfonyl nonadecylene, octylsulfonyl hexadecylene, methylthio nonadecylene, isopropylthio octadecylene, phenylsulfonyl pentadecylene, methylsulfonyl nonadecylene, nonylthio pentadecylene, phenylthio octadecylene, ethyltio nonadecylene, benzylthio undecylene, phenethylthio pentadecylene, sec-butylthio octadecylene, naphthylthio undecylene and the like; alkoxycarbonylalkylenes such as methoxycarbonylene, ethoxycarbonylene, butoxycarbonylene and the like; cycloalkylenes such as cyclohexylene, cyclopentylene, cyclo-octylene, cycloheptylene and the like; alkoxyalkylenes such as methoxy-methylene, ethoxymethylene, butoxymethylene, propoxyethylene, pentoxybutylene and the like; aryloxyalkylenes and aryloxyarylenes such as phenoxyphenylene, phenoxymethylene and the like; aryloryalkylenes such as phenoxydecylene, phenoxyoctylene and the like; arylalkylenes such as benzylene, phenthylene, 8-phenyloctylene, 10-phenyldecylene and the like; alkylarylenes such as 3-decylphenylene, 4-octylphenylene, 4-nonylphenylene and the like; and polypropylene glycol and polyethylene glycol substituents such as ethylene, propylene, butylene, phenylene, benzylene, tolylene, p-styrylene, p-phenylmethylene, octylene, dodecylene, octadecylene, methoxy-ethylene, moieties of the formula —C₃H₆CO₂—, —C₅H₁₀CO₂—, —C₇H₁₀CO₂—, —C₇H₁₄CO₂—, —C₉H₁₈CO₂—, —C₁₁H₂₂CO₂—, —C₁₃H₂₆CO₂—, —C₁₅H₃₀CO₂—, and —C₁₇H₃₄CO₂— and —C═C(CH₃)COOCH₂CH₂—, and the like. Such tetra-, tri-, and di-ammonium, -sulfonium, -phosphonium, -oxonium; ammonium/sulfonium; ammonium/phosphonium; ammonium/oxonium; phosphonium/oxonium; sulfonium/oxonium; and sulfonium/phosphonium radicals are well known in the art and can be derived from the corresponding amines, phosphines, alcohols or ethers, and sulfides.

In accordance with an important feature of the compositions, articles and methods described herein, a nanoclay concentrate can be manufactured, e.g., having about 10-90%, preferably about 20-80% nanoclay and about 10-90%, preferably about 20-80% of a matrix polymer. The nanoclay can be dispersed in the matrix polymer and optionally exfoliated, before the addition of the recycled polymer to prevent degradation of the added recycled polymer by reducing or avoiding polymer—degrading shearing. U.S. Pat. Nos. 6,462,122 and 6,632,868, herein encompassed in their entirety, disclose nanoclay concentrate forms.

When shear is employed for exfoliation, any method which can be used to apply a shear to the intercalate/matrix polymer nanocomposite composition can be used to exfoliate the platelets in the concentrate composition. The shearing action can be provided by any appropriate method, as for example by mechanical means, by thermal shock, by pressure alteration, or by ultrasonics, all known in the art. In particularly useful procedures, the concentrate composition is sheared by mechanical methods in which the intercalate concentrate, with or without the carrier or solvent, is sheared by use of mechanical means, such as stirrers, Banbury® type mixers, Brabender® type mixers, long continuous mixers, and extruders. Another procedure employs thermal shock in which shearing is achieved by alternatively raising or lowering the temperature of the concentrate composition causing thermal expansions and resulting in internal stresses which cause the shear. In still other procedures, shear is achieved by sudden pressure changes in pressure alteration methods; by ultrasonic techniques in which cavitation or resonant vibrations which cause portions of the concentrate composition to vibrate or to be excited at different phases and thus subjected to shear. These methods of shearing are merely representative of useful methods, and any method known in the art for shearing intercalates concentrate compositions may be used.

Mechanical shearing methods may be employed such as by extrusion, injection molding machines, Banbury® type mixers, Brabender® type mixers and the like. Shearing also can be achieved by introducing the nanoclay and co-intercalant oligomer(s) or polymer(s) at one end of an extruder (single or double screw) and receiving the sheared material at the other end of the extruder. The temperature of the nanoclay/intercalant oligomer or polymer composition, the length of the extruder, residence time of the composition in the extruder and the design of the extruder (single screw, twin screw, number of flights per unit length, channel depth, flight clearance, mixing zone, etc.) are several variables which control the amount of shear to be applied to the concentrate composition for exfoliation, prior to adding additional matrix oligomer or polymer.

In accordance with an important feature of the compositions, methods, and articles of manufacture described herein, it has been found that the nanoclay can be intercalated with non-polar polymer co-intercalants by direct compounding, i.e., by mixing the nanoclay, e.g., smectite clay, directly with a non-polar polyolefin oligomer or polymer and, optionally a maleic anhydride-modified oligomer or polymer (together or separately), in an extruder. Examples of intercalate concentrates can be found in U.S. Pat. Nos. 6,632,868 and 6,462,122, the disclosures of which are incorporated herein in their entirety. The resulting intercalate concentrate can be extruded into a homogeneous nanocomposite concentrate with unexpectedly homogeneous dispersion of the intercalate, and after addition of a combination of a polyolefin matrix oligomer or polymer and a maleic anhydride-modified polyolefin matrix oligomer or polymer, the nanocomposite has exceptional strength characteristics. The intercalant concentrate dispersed within the matrix oligomers or matrix polymers is a combination of exfoliated individual platelets and multi-layer tactoids dispersed in the matrix polymers. The tactoids have the thickness of at least two individual platelet layers plus one to ten, preferably one to five monolayer thicknesses of co-intercalated polyolefin and maleic anhydride-modified polyolefin intercalates, and include small multiples or aggregates of platelets, in a coplanar aggregate, having oligomer or polymer co-intercalants bonded or completed or ion-exchanged to the platelet surface(s).

Molding compositions comprising the combination of maleic anhydride-polypropylene and recycled polypropylene matrix oligomers or matrix polymers containing a desired loading of the intercalates of the described herein, and/or individual platelets obtained from exfoliation of the intercalates manufactured as described herein, are outstandingly suitable for the production of sheets, films and panels having valuable properties. Such sheets, films and panels may be shaped by conventional processes, such as vacuum processing or by hot pressing to form useful objects. The sheets and panels according to the invention are also suitable as coating materials for other materials comprising, for example, wood, glass, ceramic, metal or other plastics, and outstanding strengths can be achieved using conventional adhesion promoters, for example, those based on vinyl resins. The sheets, films and panels can be laminated to other plastic films, sheets or panels and this is preferably effected by co-extrusion, the sheets being bonded in the molten state. The surfaces of the sheets, films and panels, including those in the embossed form, can be improved or finished by conventional methods, for example by lacquering or by the application of protective films.

The nanocomposites described herein are also useful for fabrication of extruded films and film laminates, as for example, films for use in food packaging. Such films can be fabricated using conventional film extrusion techniques. The films are preferably from about 10 to about 100 microns, more preferably from about 20 to about 100 microns and most preferably from about 25 to about 75 microns in thickness.

The polymer and polymer blend compositions described herein may be shaped into final products by any of the known thermoplastic forming techniques. Non-limiting examples of suitable techniques include injection molding, extruding, pultruding, thermoforming, vacuum molding, stamping, forging, solid phase forming, rotary molding, and the like. The conditions for the various thermoplastic forming techniques, such as pressure, residence time, type of machinery, and the like, may be determined by one skilled in the art of forming thermoplastics.

The nanocomposites described herein are preferably used in storm water systems and/or geomembranes, as described below. Storm water systems include pipes and water storage systems. One example of a pipe where the disclosed nanocomposite is applicable is in a recycled polyethylene water pipe. Another example of a preferable use of the disclosed nanocomposites is in underground storm water storage systems. Underground storm water storage systems are often required by municipalities to reduce the flow of storm water into municipal water reclamation systems. The underground storm water storage systems accomplish this reduction by diverting the storm water from warehouse rooftops and large parking lots to water storage aquifers or containers. The water then slowly permeates into the water table. For these water storage systems to work they require both long term structural stability and large water volume capacities. The disclosed nanocomposites satisfy both constraints of the underground storm water storage systems and significantly reduced the environmental impact of building the underground storm water storage systems by employing recycled polymers in the structural components.

### Geotechnical Applications

An important aspect of the compositions, articles and methods described herein is the use of the herein described nanocomposites and recycled polymer nanocomposites in geotechnical applications. Examples of geotechnical applications include water management, erosion control, waste material emission control, soil stability, green construction, and the like. Specifically, this aspect relates to remarkable improvements in the materials used in geotechnical applications. These improvement to the materials include increasing the tensile strength of the materials, the flexural modulus of the materials, increasing the puncture strength of the materials, decreasing the changes in the materials due to time-dependant loading (creep), decreasing the coefficient of linear thermal expansion of the materials, decreasing the gas transmission through the materials, and increasing the chemical resistance of the materials. An added benefit of these improvements is that the herein described geosynthetic materials (the nanocomposites and/or recycled polymer nanocomposites employed in geotechnical applications) can be formed into items that meet material performance requirements yet use significantly less material, effecting cost and environmental benefits. Additionally, the improved performance parameters for the described geosynthetic materials increases the life and utility of the materials in geotechnical applications.

One specific example of a geotechnical application is paving articles. Herein, the geosynthetic materials are formed into sheets, plates, tiles, or the like and are placed in locations where foot or vehicle traffic would otherwise cause damage to the ground. Generally, these paving articles are open cell grids (herein called paving grids) that allow storm water or other liquids to flow through the grids and into the surface soil. Generally, paving articles used to construct paving systems have been constructed from precast concrete or open cell bricks due in part to the superior long term performance of these hard materials upon exposure to the environment and vehicle traffic. The herein described geosynthetic materials allow for the replacement of these hard materials and importantly reduce the percentage of the paved area that is covered by liquid-impervious materials. Paving articles made from geosynthetic materials preferably cover less than 10% of the paved area with a liquid-impervious material, more preferably less than 5%. One of them most important characteristic of the herein described geosynthetic materials for application in paving systems is the creep of the material. Materials with higher creep will deform over time compressing, and destroy the benefits of liquid permeability and soil containment. Generally, the geosynthetic materials applicable for use in a paving system include a polymer and a nanoclay. Preferably, the polymer is a structurally stable polymer, for example polyethylene, polypropylene, polystyrene, polycarbonate, polyacrylate, polyterphthalate, nylon, block polymers, co-polymers, mixtures thereof, and the like. Generally nanoclay loadings are within the range of about 0.01% to about 40% by weight, preferably about 0.05% to about 20%, more preferably about 0.5% to about 15% of the total weight of the composition. It is preferred that the nanoclay loading be less than about 15% by weight of the geosynthetic material. Additionally, the geosynthetic material can include polymer modifiers, as defined above and below.

Another example of a geotechnical application is erosion protection. Herein, the geosynthetic materials are formed into sheets, plates, tiles, webs, cups, containers or the like and are placed in locations where erosion otherwise cause loss of topsoil. Generally, these erosion protection articles are open cell grids that allow storm water to flow through the grids and into the surface soil while preventing the loss of the soil. These erosion protection articles can be installed on slopes, hills, walls, roofs, walkways, driveways, fields, plains, and the like. Generally, the geosynthetic materials used to make articles for use in an erosion protection system include a polymer and a nanoclay. Preferably, the polymer is a structurally stable polymer, for example polyethylene, polypropylene, polystyrene, polycarbonate, polyacrylate, polyterphthalate, nylon, block polymers, co-polymers, mixtures thereof, and the like. Generally nanoclay loadings are within the range of about 0.01% to about 40% by weight, preferably about 0.05% to about 20%, more preferably about 0.5% to about 15% of the total weight of the composition. It is preferred that the nanoclay loading be less than about 15% by weight of the geosynthetic material. Additionally, the geosynthetic material can include polymer modifiers, as defined above and below.

Common to both the erosion protection and paving system applications is the stabilization of a fill in the open cells of the formed geosynthetic material. Dependant upon the application, the fill can be soil, earth, stone, gravel, sand, porous cement, the like, and, optionally, non-porous material, for example, concrete. The geosynthetic materials can be used to limit water run off by permitting water to adsorb into the ground through the open cells of the above defined applications. Examples of systems that prevent the erosion of particulate materials can be found in U.S. Pat. Nos. 5,250,340, 4,896,993, and 4,067,197, the disclosures of which are incorporated herein by reference. Alternatively, the geosynthetic materials can be used as water-impervious sheets or films, “Geomembranes” to prevent water or other liquids from entering the ground.

### Geomembranes

Another aspect of the compositions, articles, and methods described herein is an improved apparatus for lining reservoirs, waste landfills, hazardous waste disposal sites, outdoor fluid containment areas and other similar applications. Specifically, this aspect relates to a moisture impervious sheet or liner, a geomembrane, particularly suitable for environmental pollution control, for example as a water barrier for the building of waste landfills, ponds, reservoirs, canal liners, drilling sump liners, soil remediation liners, tailings dam liners, interim landfill caps, or lagoons, or as a soil sealant for hazardous or nuclear waste and where the sheet or liner is capable of resisting expansion, contraction, wrinkling, bridging, deformation, and stress cracking due to thermal changes, for example upon exposure to direct sunlight or incident radiation.

Landfills, lagoons or other waste ponds are typically constructed by excavating land to create a reservoir area. If desired, berms can then be built around the perimeter of the reservoir area to extend the walls of the reservoir above ground level. Quite often, the landfill, lagoon or waste site is lined with a layer of clay to serve as a barrier. For example, environmental regulations typically require a subgrade clay layer of uniform thickness (e.g., five feet) and uniform water content. As a final step, a thermoplastic liner is installed by, for example, placing high density polyethylene (“HDPE”) or medium density polyethylene (“MDPE”) plastic sheets over the entire surface of the reservoir soil and berm area in an overlapped abutting fashion, and then welding or cementing the sheets together to create a water impermeable liner. One method of welding plastic materials, such as plastic abetting, is set of forth in U.S. Pat. No. Re. 32,103. The liner can then be covered, if desired, with a protective layer of earth to provide protection of the liner from puncturing and to help keep the liner in place.

The waste, liquid, sludge material or the like is then placed on top of the plastic sheeting which is lining the landfill, reservoir, lagoon or pond. The landfill, reservoir, lagoon or pond is subject to water or fluid level changes, thereby leaving the dark-pigmented plastic liner vulnerable to direct exposure to sunlight, particularly along the sidewalls of the landfill or berm areas. Exposure to the sunlight causes the dark-pigmented plastic liner to heat up and wrinkle, buckle, bridge, or deform due to the thermal characteristics of the plastic. Such wrinkling or buckling causes stress to be placed on the plastic sheets and the seams between each plastic sheet, thereby damaging or potentially damaging the seal created by the liner. If a hole occurs at or near a wrinkle in a geomembrane, the airspace beneath the wrinkle acts as a preferential pathway for fluid flow, thereby increasing potential leakage through the geomembrane compared with the case for a hole in a geomembrane but without a wrinkle. See Geosynthetics International, vol. 14, 219-27 (2007).

In addition, the higher temperatures caused by the absorbance of infrared radiation, by the, commonly, darkly-pigmented sheeting, can accelerate stress cracking. Thermal stress cracking is an existing problem in the (hazardous) waste liner industry. Therefore, particularly where hazardous wastes are involved, the appearance of any abnormalities in the plastic sheeting, e.g., wrinkling, cracking, or the like, will cause concern that the waste containment area is not functioning properly and will likely result in substantial time and money investments to alleviate such abnormalities.

Generally, dark pigmentation of HDPE plastic sheeting due to carbon black content imparts desirable characteristics on the plastic sheeting, such as blocking ultraviolet initiated oxidative degradation of the plastic. For example, carbon black inhibits the formation of free radicals and carbonyl groups which could otherwise form in polyethylene upon exposure to ultraviolet light, thereby preventing the free radicals and carbonyl groups from catalyzing the degradation of the polyethylene and preventing the acceleration of cracking. However, the dark pigmentation of HDPE plastic sheeting absorbs sunlight or incident radiation thereby heating and potentially causing damage to the plastic sheeting. While exposed plastic liners can be protected from sunlight by covering the liner with dirt, this procedure may not be desirable or practical, and may limit the ability to visually inspect the exposed portions of the liner for any tears or other undesirable perforations or leaks. Additionally, sections of lined landfills are typically left exposed until the section is ready for waste disposal which may not be for several years. Therefore the potential for the development of abnormalities in the plastic sheeting is exacerbated by the long term environmental exposure.

Alternative methods have been developed to attempt to overcome the wrinkling of the geomembranes. One direct approach is changing the color of the geomembrane thereby reflecting more light (and heat), as described in US Pat. No. 6,197,398.

The prior art does not teach or suggest that the wrinkling and/or cracking of the geomembranes can be prevented by replacing a virgin plastic, e.g. HDPE, with an similar or corresponding nanocomposite, e.g. LDPE nanocomposite or HDPE nanocomposite, respectively. Theoretically, the nanocomposite does not wrinkle and/or crack under the environmental that cause failure of the virgin plastic because of the lower coefficient of thermal expansion of the nanocomposites compared with that of the virgin plastic. Moreover, the prior art does not suggest that the replacement of the virgin plastic with a nanocomposite would impart added benefits in geomembrane applications, like landfills, water retention basins, and the like. Importantly, the herein described geomembranes are unexpected improvements over the current art because they resist thermal and photo degradation, they have lower gas permeability, they have higher puncture resistance, and have higher chemical resistance.

Herein, geomembranes are made from a material that has a low coefficient of thermal expansion and a high puncture resistance. Lowering the coefficient of thermal expansion inhibits the formation of wrinkles in a geomembrane by preventing the expansion and contraction of the material upon exposure to heat (or light). The excellent results obtained for the herein described geomembranes show coefficient of linear thermal expansion (ASTM D 696) cut by over 50%, as compared to typical plastic sheeting.

Moreover, the decrease in the coefficient of linear thermal expansion is accompanied by an increase in the puncture resistance of the geomembrane. Detrimental the application of the geomembrane in, for example, landfill applications is the puncture of the geomembrane. The puncture of the geomembrane is as detrimental if not worse than the formation of wrinkles on exposed geomembranes because the puncture can often go undetected and permit noxious materials to leach in to the water table. Therefore a puncture strength as high as possible is a desirable characteristic of the geomembrane, herein the described geomembranes have puncture strengths approximately 100% greater than those previously reported for polyethylene films.

Yet another beneficial aspect of the herein described geomembranes is the enhanced impermeability of the geomembrane to gases that can evolve from, for example, landfills. Particularly hazardous to the environment and by-standers is the evolution of methane from landfills. Herein the geomembranes extraordinarily display a greater than 80% decrease in the permeability of methane as compared to standard polyethylene films.

The extraordinarily combination of these three characteristics in the described geomembranes, decreased coefficient of linear thermal expansion, increased puncture strength, and significantly decreased methane transmission, make these geomembranes extraordinarily useful and applicable.

The herein described geomembranes are made by combining polymers and nanoclays. This nanocomposite is a mixture of a polymer and a clay that has been at least partially exfoliated. The nanocomposite may contain virgin polymer, recycled polymer, or a mixture of the virgin and recycled polymer. The method of mixing the polymer and the clay can include chopping, grinding, extruding, blending, and/or any other method know in the art to mix polymers with clays.

In particular sheets and films of propylene, maleic anhydride-polypropylene, recycled polypropylene, low density polyethylene, and/or recycled polyethylene containing a desired loading of the intercalates of the present invention, and/or individual platelets obtained from exfoliation of the intercalates manufactured according to the present invention, are outstandingly suitable for the production of geomembranes. The geomembranes may be shaped by conventional processes, such as vacuum processing or by hot pressing. The geomembranes can be laminated to other plastic films, sheets or panels and this is preferably effected by co-extrusion, the sheets being bonded in the molten state. The surfaces of the geomembranes, including those in the embossed form, can be improved or finished by conventional methods, for example by lacquering or by the application of protective films.

An added and environmentally beneficial aspect of the herein described geomembranes is the use of recycled polymers in the formation of the geomembrane. Generally, geomembranes cover very large areas and are inherently not recyclable because of their location under waste sites. The use of recycled materials, especially the herein described nanocomposites, in geomembrane applications decreases the environmental impact of the construction of landfills, water retention basins, and the like.

Examples and testing data from the geomembrane films defined herein can be understood from the, non-limiting, examples presented in Example 1. There low density polyethylene geomembranes were prepared as tested.

### Storm Water Systems

Another aspect of the compositions, articles, and methods described herein generally relates to the retention or detention of fluids, typically storm water. Storm water distribution systems, e.g., storm water retention/detention systems, are used to accommodate runoff at a given site by diverting or storing storm water and preventing pooling of water at the ground surface.

An underground storm water retention/detention system is generally utilized when the surface area on a building site is not available to accommodate other types of systems such as open reservoirs, basins or ponds. The underground systems do not utilize valuable surface areas as compared to reservoirs, basins or ponds. Underground systems are also advantageous in that they present fewer public hazards than other systems. Another advantage is that underground systems avoid having open, standing water which would be conducive to mosquito breeding. Underground systems also avoid the aesthetic problems of other systems such as algae growth and weed growth which can occur in other systems. Thus it is beneficial to have an underground system to manage storm water effectively.

Water retention/detention systems store and release water at a controlled rate in accordance with increasingly stringent environmental requirements. Storm water retention/detention systems have become standard features on site development projects where buildings, roads and parking lots have limited the site's ability to absorb water. In response, many state and municipal agencies have limited the rate at which storm water can be discharged into local streams. A detention pond is often constructed at new developments to store and release water at a designated rate. Where land is valuable or where space is limited or where other concerns are present retention/detention systems are constructed underground. See, for example, U.S. Pat. Nos. 6,796,325, 6,702,517, and 4,620,817.

In accordance with prior procedures, engineers have provided various means for directing storm water into the earth for storage and disposal. For example crushed stone pits have been employed, frequently with perforated pipes therein. Large diameter pipes have traditionally been used to construct below grade retention/detention systems. Typically these systems involve a series of parallel pipes placed on a prepared bed at the bottom of an excavation. The pipes must be adequately spaced, backfilled with a select soil and covered to a minimum height. Various shaped or molded structures made of concrete, steel or plastic have been employed. When the water retention/detention system will underlie buildings, roads, and/or parking lots preformed concrete structures are commonly employed. Plastic structures have been attempted are commercially available but spectacular failures of plastic water retention/detentions systems are well known. See e.g., R. M. Zallen “Collapse of Underground Storm Water Detention System” March 2008.

One reason for the failure of plastic water retention/detention systems is the weakening of the plastic structure over time and/or under load. One measure of the weakening of plastic structures over time is a time-dependant loading, otherwise known as creep. The creep of the plastic over time structurally deforms the plastic structure and decreased its overall capacity to support a load. While multiple attempts to design plastic water retention/detention systems are known, herein the deficiency in the plastic waster retention/detention system is overcome by significantly improving the plastic, i.e. by reducing the creep.

The reduction of the creep of the plastic decreased the amount of material needed to construct the water retention/detention system. Preferably the water retention/detention system has at least about a 80% void space, as used herein void space is the percentage of the total volume of the water retention/detention system open for the addition of water. When the water retention/detention system is composed of cubic parts, the percentage of the cubic volume not filled by structural material, herein including the nanocomposite, is the void space. More preferably, the water retention/detention system has at least about a 90% void space. Preferably the water retention/detention system has a void space greater than 95%.

Additionally, an important aspect of the present disclosure is an added improvement in the chemical resistance of the plastic as measured by the environmental stress crack resistance (ESCR) (ASTM D1693). It is well understood that storm water systems must handle significant amounts of hazardous waste products that potentially flow from vehicles or businesses. Particularly disadvantageous to plastic structures are the organic liquids that can be carried into storm water retention/detention systems, e.g., motor oil, antifreeze, gasoline, diesel, etc. The systems presented herein show significant improvements in the ESCR thereby reinforcing the structural superiority of the herein presented nanocomposite produced systems. These improvements, reduced creep and increased chemical resistance, should exponentially increase the useful life span of the plastic water retention/detention systems.

The use of the herein described storm water systems furthers federal and local governments' directives of Leadership in Energy and Environmental Design (LEED) Project Certification. Many federal departments and local municipalities require LEED certification, wherein storm water control, innovative wastewater technologies, and use of recycled content (e.g., polymers) are important in obtaining certification. Herein the combinations of the geomembranes, the storm water systems, and the nanocomposites furthers compliance with governmental policy and respect for the environment.

### Geonets

Another aspect of the compositions, articles, and methods described herein generally relates to the support of materials and drainage through the supporting elements of liquids and lechates. Geonets are one form of a support material that allow liquids and lechates to flow through. One example of geonets are those formed of a plurality of layers of polymeric ribs joined at their junctions, therein the supporting elements. In an preferable embodiment, the polymeric ribs in one layer of the polymeric ribs are parallel. In another embodiment the polymeric ribs in one layer can be curved, for example sinusoidal, wherein the polymeric ribs follow the same curvature. In yet another embodiment, the polymeric ribs can be woven together, wherein polymeric ribs with one longitudinal direction constitute one layer. The plurality of layers can be orthogonal or acute. Preferably, the layers are acute because a geonet having a plurality of acute layers can expand and the volume of an aperture can increase. For example, when the ribs are expanded, relatively large apertures are formed into a netlike configuration.

In applications, for example landfill liner, the geonet drainage material is subject to a static compressive load from the landfill waste throughout the service lifetime. Due to viscoelastic properties of the support materials, creep deformation of the geonet under compression load results in reduced flow rate. Research has shown that the creep deformation of geonet is strongly governed by the cross-sectional design and the creep characteristics of the material used. Higher resistance to creep deformation offers a smaller reduction factor and a greater long term flow rate. Commonly, HDPE is used as the support material but these materials exhibit creep deformation during the lifetime of the geonet. The herein described nanocomposites, that include a polymer, a nanoclay, and a polymer modifier, exhibit significantly less creep deformation and are therefore preferable for the formation of geonets.

The foregoing description is given for clearness of understanding only, and no unnecessary limitations should be understood therefrom, as modifications within the scope of the invention may be apparent to those having ordinary skill in the art.

Throughout the specification, where compositions are described as including components or materials, it is contemplated that the compositions can also consist essentially of, or consist of, any combination of the recited components or materials, unless described otherwise. The invention illustratively disclosed herein suitably may be practiced in the absence of any element or step which is not specifically disclosed herein.

The practice of a method disclosed herein, and individual steps thereof, can be performed manually and/or with the aid of or automation provided by electronic equipment. Although processes have been described with reference to particular embodiments, a person of ordinary skill in the art will readily appreciate that other ways of performing the acts associated with the methods may be used. For example, the order of various of the steps may be changed without departing from the scope or spirit of the method, unless described otherwise. In addition, some of the individual steps can be combined, omitted, or further subdivided into additional steps.

All patents, publications and references cited herein are hereby fully incorporated by reference. In case of conflict between the present disclosure and incorporated patents, publications and references, the present disclosure should control.

### Examples

The following examples are provided to illustrate the invention, but are not intended to limit the scope thereof.

### Example 1

### Low Density Polyethylene Nanocomposite Sheets

Low density polyethylene (LDPE) was processed into nanocomposite sheets. A masterbatch(nanoclay concentrate)-letdown approach was implemented to allow for the highest dispersion of nanoclay into LDPE.

As a first step, low density polyethylene was dry blended with a nanoclay masterbatch (e.g., nanoMax-LDPE (NANOCOR INC, Hoffman Estates Ill.), a 50/50 blend of a dimethyl dialkyl ammonium modified montmorillonite clay and LDPE with a maleic anhydride grafted polyethylene compatibilizer). The blended product was then compounded with a twin screw extruder to collect nanocomposite pellets. In a second step, the nanocomposite pellets were dried and extruded into sheet using twin screw extruder equipped with slot die. Nanocomposite sheets with 25 mm thickness were collected.

Compounding Parameters for Letdown of LDPE Nanocomposites: Leistritz 28 mm Twin Screw Extruder (L/D=40) with high shear screw design. Formulation was bag mixed and fed by calibrated volumetric feeder into extruder feed throat.

| | | |
|---|---|---|
| Temperature Profile | 330° | F. Barrel temperature |
| Die temperature | 340° | F. |
| Roller Temp | 160° | F. |
| Screw speed | 500 | rpm. |
| Line speed | 20 | lbs/hr |
| Vacuum | −24″ | Hg |
| Sample Collected | 5 | lbs |

Extrusion Parameters for LDPE and HDPE Nanocomposites Sheets: Leistritz 28 mm Twin Screw Extruder (L/D=40) with low shear screw design with a 12 inch wide Slot Die with 25 mm gap. Samples were fed by volumetric feeder into the extruder feed throat.

| | | |
|---|---|---|
| Temperature Profile | 355° | F. Barrel temperature |
| Die temperature | 365° | F. |
| Roller Temp | 160° | F. |
| Screw speed | 250 | rpm. |
| Line speed | 7 | lbs/hr |
| Vacuum | −24″ | Hg |
| Sample Collected | 30 | ft |

The samples prepared are listed in Table 1 and physical property testing data from standard ASTM test methods are included in Table 2.

TABLE 1
LDPE Extruded Sheet Samples.

| | | MB Loading | PE Loading | Thickness |
|---|---|---|---|---|
| Sample ID | Sample Description | (%) | (%) | (mm) |
| LD-C | Pure LDPE control | 0 | 100 | 25 |
| LD-3 | 3% Nano in LDPE | 6 | 94 | 25 |
| LD-6 | 6% Nano in LDPE | 12 | 88 | 25 |
| LD-9 | 9% Nano in LDPE | 18 | 82 | 25 |

TABLE 2
Summary of Test Results of Low Density Polyethylene Nanocomposites.

| | | | |
|---|---|---|---|
| LD-C | LD-3 | LD-6 | LD-9 |

Tensile Properties - from film (ASTM D 6693 - 2ipm strain rate)

| | | | | |
|---|---|---|---|---|
| MD Yield Strength (psi) | 1400 | 1711 | 1787 | 1864 |
| TD Yield Strength (psi) | 1381 | 1698 | 1744 | 1897 |
| MD Break Strength (psi) | 4574 | 4829 | 4846 | 4918 |
| TD Break Strength (psi) | 5208 | 5011 | 5057 | 4869 |
| MD Yield Elongation (%) | 18.3 | 20.2 | 20.1 | 21.4 |
| TD Yield Elongation (%) | 16.2 | 19.8 | 19.2 | 18.9 |
| MD Break Elongation (%) | 867 | 896 | 878 | 903 |
| TD Break Elongation (%) | 999 | 909 | 914 | 930 |

Tensile Properties - from compression molded plaques
(ASTM D 6693 - 2ipm strain rate)

| | | | | |
|---|---|---|---|---|
| Yield Strength (psi) | 1662 | 1805 | 1881 | 1966 |
| Break Strength (psi) | 4327 | 4316 | 4395 | 4367 |
| Yield Elongation (%) | 20.5 | 20.4 | 19.5 | 19.2 |
| Break Elongation (%) | 839 | 801 | 808 | 796 |
| 0.02 Secant Modulus (psi) | 44111 | 49188 | 53784 | 56173 |
| Young's Modulus (psi) | 50153 | 61459 | 65157 | 62197 |

Puncture Properties (ASTM Dc 4833)

| | | | | |
|---|---|---|---|---|
| Puncture Strength (lbs) | 31.7 | 49.9 | 50.3 | 54.4 |
| Displacement @ max load (inches) | 1.09 | 1.05 | 1.02 | 1.00 |

Coefficient Of Linear Thermal Expansion (ASTM D 696)

| | | | | |
|---|---|---|---|---|
| CLTE (μm/m/° C.) - 5 g - film | 172 | 109 | 85 | 83 |

Methane Transmission (ASTM D 1434, Method V)

| | | | | |
|---|---|---|---|---|
| Permeation (cm²/sec-atm) | 6.3 × 10⁻⁸ | 5.2 × 10⁻⁸ | 1.1 × 10⁻⁸ | 1.0 × 10⁻⁸ |
| Permeation [(cm³)(cm)/(cm²)(sec)(Pa)] | 6.2 × 10⁻¹³ | 5.1 × 10⁻¹³ | 4.0 × 10⁻¹³ | 3.9 × 10⁻¹³ |

Time-Dependent Loading (ASTM D 6992 - Creep
at 500 psi Stress) - compression molded plaques

| | | | | |
|---|---|---|---|---|
| Strain at 10000 hours (%) | 12.00 | 9.48 | 8.50 | 7.21 |
| Strain at 50 Years (%) | 18.48 | 14.76 | 13.25 | 11.09 |

### Example 2

### High Density Nanocomposite Sheets

High density polyethylene (HDPE) was processed into nanocomposite sheets using the process presented in Example 1. All parameters were held constant, although the HDPE was blended with nanoMax-HDPE (NANOCOR INC.; a 50/50 blend of a dimethyl dialkyl ammonium modified montmorillonite clay and HDPE with a maleic anhydride grafted polyethylene compatibilizer). The samples prepared are listed in Table 3 and physical property testing data from standard ASTM test methods are included in Tables 4 and 5.

TABLE 3
HDPE Extruded Sheet Samples.

| | | MB Loading | PE Loading | Thickness |
|---|---|---|---|---|
| Sample ID | Sample Description | (%) | (%) | (mm) |
| HD-C | Pure HDPE control | 0 | 100 | 25 |
| HD-3 | 3% Nano in HDPE | 6 | 94 | 25 |
| HD-6 | 6% Nano in HDPE | 12 | 88 | 25 |
| HD-9 | 9% Nano in HDPE | 18 | 82 | 25 |

TABLE 4
Summary of Test Results of High Density Polyethylene Nanocomposites.

| | | | |
|---|---|---|---|
| HD-C | HD-3 | HD-6 | HD-9 |

Tensile Properties - from film (ASTM D 6693 - 2ipm strain rate)

| | | | | |
|---|---|---|---|---|
| MD Yield Strength (psi) | 2227 | 2727 | 2824 | 3299 |
| TD Yield Strength (psi) | 2316 | 2781 | 3103 | 3283 |
| MD Break Strength (psi) | 4081 | 4319 | 4385 | 4562 |
| TD Break Strength (psi) | 4829 | 5011 | 5086 | 4796 |
| MD Yield Elongation (%) | 14.7 | 18.7 | 19.2 | 15.8 |
| TD Yield Elongation (%) | 17.2 | 18.6 | 18.2 | 18.1 |
| MD Break Elongation (%) | 558 | 598 | 549 | 643 |
| TD Break Elongation (%) | 762 | 748 | 700 | 802 |

Tensile Properties - from compression molded plaques
(ASTM D 6693 - 2ipm strain rate)

| | | | | |
|---|---|---|---|---|
| Yield Strength (psi) | 2614 | 2832 | 3180 | 3477 |
| Break Strength (psi) | 4587 | 4438 | 3997 | 2464 |
| Yield Elongation (%) | 16.1 | 15.6 | 14.8 | 14.2 |
| Break Elongation (%) | 789 | 784 | 744 | 420 |
| 0.02 Secant Modulus (psi) | 76445 | 85647 | 102280 | 112883 |
| Young's Modulus (psi) | 84471 | 94725 | 122948 | 135214 |

Time-Dependent Loading (ASTM D 6992 - Creep at
500 psi Stress) - compression molded plaques

| | | | | |
|---|---|---|---|---|
| Strain at 10000 hours (%) | 2.83 | 2.50 | 1.88 | 1.81 |
| Strain at 50 Years (%) | 3.42 | 2.99 | 2.32 | 2.26 |

Methane Transmission (ASTM D 1434, Method V)

| | | | | |
|---|---|---|---|---|
| Permeation (cm²/sec-atm) | 3.3 × 10⁻⁸ | 2.0 × 10⁻⁸ | 1.7 × 10⁻⁸ | 1.6 × 10⁻⁸ |
| Permeation [(cm³)(cm)/(cm²)(sec)(Pa)] | 3.2 × 10⁻¹³ | 2.0 × 10⁻¹³ | 1.7 × 10⁻¹³ | 1.6 × 10⁻¹³ |

TABLE 5
Environmental Stress Crack Resistance (ESCR) (ASTM D 1693)

| Samples | HD-C | HD-3 | HD-6 |
|---|---|---|---|
| ESCR (h) | 42 | 94 | 141 |

### Example 3

### The Use of Recycled Plastics in Feed Stream in Producing Nanocomposites (6% Nanoclay Loading)

Polypropylene (PP) nanocomposites were prepared following procedure detailed in Example 1. The recycled PP nanocomposite was prepared by regrinding molded parts of PP nanocomposite. The compounding and molding steps in this example followed the same parameters as in Example 1.

Table 6 shows that addition of up to 30% recycled plastics in the feed stream has little effect in degrading the final properties. For virgin plastics without any nanoclay, addition of 30% recycled plastics would cause property degradation of 30-40%.

TABLE 6
Addition of Recycled PP Nanocomposites (with 6 wt % of clay) into Feed Stream

| | | | wt % of | Flx. | Flx. | | Notched |
|---|---|---|---|---|---|---|---|
| | | wt % of | Recycled | Str | Mod | Change | Izod (lbs- |
| Sample ID | Formulation | Nanoclay | nano PP | (kpsi) | (kpsi) | (%) | ft/in) |
| Re-C | 100% nano PP | 6 | 0 | 8.657 | 331.6 | | 0.81 |
| Re-10 | 10% Recy | 6 | 10 | 8.541 | 327.7 | −1.2 | 0.62 |
| | NanoPP + 90% | | | | | | |
| | nano PP | | | | | | |
| Re-20 | 20% Recy | 6 | 20 | 8.497 | 314.5 | −5.2 | 0.74 |
| | NanoPP + 80% | | | | | | |
| | nano PP | | | | | | |
| Re-30 | 30% Recy | 6 | 30 | 8.483 | 317.3 | −4.3 | 0.72 |
| | NanoPP + 70% | | | | | | |
| | nano PP | | | | | | |

### Example 4

### The Use of Recycled Plastics in Feed Stream in Producing Nanocomposites (12% Nanoclay Loading)

The PP nanocomposites in this example was prepared following procedure detailed in Example 1, with addition of 20 wt % of an impact modifier (ENGAGE 8150, DOW Automotive, Auburn Hills, Mi) in the formulation. The recycled PP nanocomposite was prepared by regrinding molded parts of PP nanocomposite. The compounding and molding steps in this example follow the same parameters as in Example 1.

Table 7 shows that addition of up to 50% recycled plastics in the feed stream has little effect in degrading the final properties. For virgin plastics without any nanoclay, addition of 50% recycled plastics would cause property degradation of 30-40%.

Table 7 further shows the PP nanocomposite retains the physical properties even with 100% recycled feed stock (sample Rc-100). Virgin plastics without any nanoclay would show 40% property degradation under same circumstance.

TABLE 7
Addition of Recycled PP Nanocomposites
(with 12 wt % of clay) into Feed Stream

| | Sample ID | | | | | |
|---|---|---|---|---|---|---|
| | Rc-C | Rc-10 | Rc-20 | Rc-30 | Rc-50 | Rc-100 |
| Virgin nano PP | 100 | 90 | 80 | 70 | 50 | 0 |
| Loading | | | | | | |
| Recycle nano | 0 | 10 | 20 | 30 | 50 | 100 |
| PP Loading | | | | | | |
| wt % of | 12 | 12 | 12 | 12 | 12 | 12 |
| Nanoclay | | | | | | |
| Ten. Str (kpsi) | | 3.89 | 3.83 | 3.87 | 3.76 | 3.8 |
| Ten Mod (kpsi) | | 258.4 | 240 | 243.2 | 225.9 | 234.2 |
| Elong @ Brk | | 26 | 29 | 28 | 36 | 29 |
| (%) | | | | | | |
| Flx. Str (kpsi) | 5.66 | 5.45 | 5.39 | 5.41 | 5.45 | 5.42 |
| Flx. Mod (kpsi) | 266.1 | 264.8 | 260 | 255.1 | 263.9 | 250 |
| Change (%) | | −0.5 | −2.3 | −4.1 | −0.3 | −3.8 |
| Notched Izod | 7.5 | 7.5 | 7.7 | 8.7 | 8.7 | 9 |
| (lbf-ft/in) | | | | | | |

1. A nanocomposite comprising a recycled polymer and a nanoclay; wherein prior to admixing the recycled polymer with the nanoclay the recycled polymer is essentially free of nanoclay.

2. A process of recycling a polymer to form a nanocomposite comprising forming an article from a mixture of a recycled polymer and a nanoclay; and wherein prior to admixing the recycled polymer with the nanoclay, the recycled polymer is essentially free of a nanoclay.

3. A process of recycling a nanocomposite comprising reforming an article from a nanocomposite; wherein the nanocomposite is post-consumer and/or post-industrial waste; and wherein the flexural modulus of the nanocomposite changes less than about 5% upon multiple reformings.

4. An article of manufacture comprising a noncomposite formed by admixing a polymer essentially free of nanoclay, and nanoclay, and a polymer modifier, wherein the article is made by shaping the nanocomposite into the article of manufacture.

5-17. (canceled)

18. The nanocomposite of claim 1, wherein the nanocomposite consists essentially of the recycled polymer and the nanoclay.

19. The nanocomposite of claim 1, wherein the nanocomposite consists essentially of the recycled polymer, the nanoclay, and a compatibilizer.

20. The nanocomposite of claim 1, wherein the nanocomposite comprises about

0. 1 to about 15 wt. % nanoclay; and wherein the recycled polymer comprises 0% to 100% by weight of a post consumer product, 0% to 100% by weight of a post industrial product, and 0% to about 99% by weight of a virgin polymer.

21. The nanocomposite of claim 1, wherein the recycled polymer is selected from the group consisting of polyethylene terephthalate, polyethylene, polyvinylchloride, polypropylene, polystyrene, polycarbonate, nylon, and a mixture thereof.

22. The nanocomposite of claim 1 further comprising a polymer modifier selected from the group consisting of an antiblocking agent, an antistatic agent, an antioxidant, a blowing agent, a polymer compatiblizer, a crystallization aid, a dye, an extender, a flame retardant, a filler, an impact modifier, a mold release agent, an oil, a pigment, a performance additive, a plasticizer, a processing agent, a reinforcing agent, a polymer stabilizer, an UV light absorber, a photostabilizer for a UV light absorber, and a mixture thereof.

23. The nanocomposite of claim 22, wherein the polymer modifier is a polymer compatiblizer.

24. The nanocomposite of claim 1, wherein a flexural modulus value of the nanocomposite is within about 10% of a flexural modulus value of a nanoclay-virgin polymer-nanocomposite containing the same wt. % of the same nanoclay.

25. The nanocomposite of claim 24, wherein the recycled polymer comprises polypropylene, and wherein the flexural modulus value of the nanocomposite is within about 5% of a flexural modulus value of the nanoclay-virgin polypropylene-nanocomposite.

26. The process of claim 2, wherein the nanocomposite comprises about 0.1 to about 15 wt. % nanoclay; and wherein the recycled polymer comprises 0% to 100% by weight of a post consumer product, 0% to 100% by weight of a post industrial product, and 0% to about 99% by weight of a virgin polymer.

27. The process of claim 2, wherein the flexural modulus value of the nanocomposite is within about 10% of a flexural modulus value of a nanoclay-virgin polymer-nanocomposite containing the same wt. % of the same nanoclay.

28. The process of claim 27, wherein the mixture is formed by admixing the recycled polymer with a nanoclay concentrate.

29. The process of claim 27, wherein a tensile strength of the nanocomposite is greater than a tensile strength corresponding to an article formed from the virgin polymer that contains no nanoclay.

30. The article of claim 4, wherein the polymer comprises 0% to 99% by weight of a virgin polymer and 1% to 100% by weight of a recycled polymer that consists of 0% to 100% by weight post consumer polymer and 0% to 100% by weight of a post industrial polymer.

31. The article of claim 4, wherein the polymer modifier is selected from the group consisting of an antiblocking agent, an antistatic agent, an antioxidant, a blowing agent, a polymer compatiblizer, a crystallization aid, a dye, an extender, a flame retardant, a filler, an impact modifier, a mold release agent, an oil, a pigment, a performance additive, a plasticizer, a processing agent, a reinforcing agent, a polymer stabilizer, an UV light absorber, a photostabilizer for a UV light absorber, and a mixture thereof.

32. The article of claim 30, wherein the polymer modifier is a polymer compatibilizer.

33. The article of claim 4, wherein the time-dependant deformation (ASTM D 6992) of the nanocomposite is less than that of the virgin polymer that contains no nanoclay.

34. The article of claim 33, wherein the recycled polymer comprises low density polyethylene, the time-dependant deformation at 10,000 hours is less than about 10%, and the time-dependant deformation at 50 years is less than about 15%.

35. The article of claim 34, wherein the time-dependant deformation at 10,000 hours is less than about 8.5%, and the time-dependant deformation at 50 years is less than about 13.5%.

36. The article of claim 33, wherein the recycled polymer comprises high density polyethylene, the time-dependant deformation at 10,000 hours is less than about 2.5%, and the time-dependant deformation at 50 years is less than about 3.0%.

37. The article of claim 36, wherein the time-dependant deformation at 10,000 hours is less than about 2%, and the time-dependant deformation at 50 years is less than about 2.5%.

38. The article of claim 4, wherein a methane transmission (ASTM D 1434, Method V) value is less than about 6.0×10⁻⁸ cm²sec⁻¹ atm⁻¹.

39. The article of claim 38, wherein the methane transmission value is less than about 3.0×10⁻⁸ cm²sec⁻'atm⁻¹.

40. The article of claim 39, wherein the methane transmission value is less than about 2.0×10⁻⁸ cm²sec^{-'}atm⁻¹.

41. The article of claim 40, wherein the methane transmission value is less than about 1.1×10⁻⁸ cm²sec⁻'atm⁻¹.

42. The article of claim 4, wherein a environmental stress crack resistance value (ASTM D 1693) is greater than 50 hours.

43. The article of claim 4, wherein a coefficient of linear thermal expansion (ASTM D 696) is less than a coefficient of linear expansion of a corresponding virgin polymer.

44. The article of claim 4, wherein the nanocomposite comprises about 0.1 to about 15 wt. % nanoclay; and wherein the recycled polymer comprises 0% to 100% by weight of a post consumer product, 0% to 100% by weight of a post industrial product, and 0% to about 99% by weight of a virgin polymer.

45. The article of claim 44, wherein a flexural modulus value of the nanocomposite is greater than about 90% of the flexural modulus value of a nanoclay-virgin polymer-nanocomposite containing the same wt. % of the same nanoclay.

46. The article of claim 45, wherein the flexural modulus value of the nanocomposite is greater than about 95% of the flexural modulus value of a nanoclay-virgin polymer-nanocomposite containing the same wt. % of the same nanoclay.

47. The article of claim 4, wherein the article is selected from the group consisting of a storm water distribution structure, a geomembrane, a paving grid, an erosion protection system, and a geonet.

48. The article of claim 47, wherein the article comprises a geomembrane and the polymer comprises low density polyethylene.

49. The article of claim 47, wherein the storm water distribution structure has a void space of at least 80%.

50. The article of claim 49, wherein the void space is at least 90%.

51. The article of claim 50, wherein the void space is at least 95%.

52. The article of claim 47, wherein the storm water distribution structure is a pipe.

53. The article of claim 47, wherein the storm water distribution structure is an underground storm water detention system.
